(19) United States
(12) Patent Application Publication
(10) Pub. No.: US 2009/0183537 A1
(43) Pub. Date: Jul. 23, 2009

(54) MULTI-PURPOSE DETACHABLE LOCK CONTAINER AND METHOD OF USE

(76) Inventors: An-Ting Yen, Chien-Ho City (TW); Chi-Chang Tsai, Chien-Ho City (TW)

Correspondence Address: SHERIDAN ROSS PC, 1560 BROADWAY, SUITE 1200, DENVER, CO, 80202, US

(21) Appl. No.: 12/414,345

(22) Filed: Mar. 30, 2009

Related U.S. Application Data
(63) Continuation of application No. 11/620,368, filed on Jan. 5, 2007.

(30) Foreign Application Priority Data
Jan. 5, 2006 (TW) 95100503

(51) Int. Cl. E05B 65/52

(52) U.S. Cl. 70/63

(57) ABSTRACT

A lockable container comprising a lock portion and a container is provided. The lock portion has a first part and a second part, wherein the first part has an opening component and at least a lock mechanism, the second part has at least a latch driven by the opening component. The container fits the second part. The container has at least an inner space and a wedge corresponding to the latch. The lock mechanism restricts a displacement of the opening component when the lock mechanism is locked. The lock mechanism releases the opening component when the lock mechanism is unlocked.

### CROSS REFERENCE TO RELATED APPLICATION

The present application claims priority under 35 U.S.C. §119 to Taiwanese Patent Application No. 095100503 filed on Jan. 5, 2006, the contents of which are incorporated herein by reference in their entirety.

### BACKGROUND OF THE INVENTION

1. Field of the Invention

The present invention generally relates to a lockable container, and more particularly, the present invention relates to a lockable container or box for securing articles deposited in the container or box and having a detachable lock for use in locking other articles other than the box or container.

2. Description of the Prior Art

Prior art lockable containers can be used, for example, to securely store keys in a location that is external to a house. In particular, the keys are placed inside a lockable container that is opened by means of a dial or combination lock. The box additionally contains a shackle that is unlocked by a separate means such as a key. The shackle is used to secure the lockable container to an object such as a door handle. A user can take out a key from the lockable container by opening the combination lock of the lockable container and then enter the house by using the key.

As can be appreciated, depositing keys in the lockable container is safer than hiding the keys under a mat, in a flowerpot, on a door frame or in some other obvious location. A typical prior art lock box is illustrated in FIG. 1a and FIG. 1b. Lock boxes such as these are made for a specific purpose and are not available for other purposes, nor do they come in a variety of shapes designed to specifically accommodate a variety of objects. Additionally, prior art lock boxes do not allow allow the lock box to be physically detached from the shackle portion while the shackle remains attached to an object, such as a door knob or handle.

Consumer electronics products such as mobile phones, MP3 players, digital cameras, flash disks and portable game players are popular and are getting lighter and smaller. It is common to carry one or more of these kinds of products at the same time. Notably, these products are high-priced and popular. Accordingly, they are likely to be stolen unless they are protected. Moreover, some of these products may store personal data. Besides the loss of the products themselves, losing these products may result in the loss of personal data that could lead to further problems.

Securing these products while simultaneously enjoying use of them is an important issue. Prior art lock boxes are not usable for securing consumer electronics or other personal item for several reasons. First, the lock boxes are not shaped appropriately to accommodate electronic devices or personal items. Second, the control panels of the electronic device cannot be accessed while the device is in the lock box. Third, prior art lock boxes are bulky and heavy because of their metal construction. Fourth, lock boxes are designed to attach to door knobs and similar fixed objects, not to a piece of clothing or other less sturdy and mobile personal items, such as back packs, purses, belts and the like. Accordingly, it would be advantageous to provide a lock box that is designed for and provides convenient access to electronic devices or other personal items and is light weight but nonetheless robust and secure.

### SUMMARY OF THE INVENTION

The present invention is directed to a lockable container for securing consumer electronics or other valuable articles. Lockable containers of the present invention may be dustproof, waterproof, or shockproof. In accordance with embodiments of the present invention, various types of lockable containers are disclosed that incorporate various sizes of containers designed to accommodate various types of articles to be secured by end users.

The present invention is directed to a lockable container having a lock portion and a box or container. The lock portion has a first part and a second part. The first part of the lock portion has at least an opening component and a lock mechanism. The second part of the lock portion has at least a latch that is movable together with the opening component. A portion of the container fits over the second part. The container defines an inner space to retain an object or device and has a latch engaging member corresponding to the latch. The latch engaging member may be a wedge shaped body, a recessed portion, an aperture, or another latch-receiving member. When locked, the lock mechanism disables the opening component. In one embodiment, this is accomplished by restricting the displacement of an associated axis rod. When unlocked, the lock mechanism enables activation of the opening component. In one embodiment this is accomplished by allowing the displacement of the associated axis rod. When the lock mechanism is in an unlocked state, the container may be separated from the lock portion by pressing the opening component.

The lockable container of the present invention also includes an attaching device such as a cable, chain, or shackle that is used to connect the lock portion to an object or article of clothing. An end of the attaching device is released by a release mechanism that is disposed on the first part of the lock portion. In accordance with embodiments of the present invention, the release mechanism is covered by a portion of the container when the container is attached to the lock portion. Additionally, the release mechanism may be coupled to or associated with the opening component such that it is necessary to activate both in order release the attaching device. Accordingly, in such an embodiment, the attaching device can only be released if the lock mechanism is unlocked. This allows the lock portion itself to be usable for securing articles regardless of whether or not a container is attached. In particular, the attaching device may be threaded through a closed loop article that is to be secured, such as key chain, through or around an object to which the article is to be secured, such as a belt loop or fixed object, and then reattached to the lock portion. Alternatively, the lock portion may be used like a pad lock by threading the attaching device through a latch mechanism such as on the front of a locker.

### BRIEF DESCRIPTION OF THE DRAWINGS

FIG. 1a is a perspective view showing a lock box of the prior art;

FIG. 1b is another perspective view of the device shown in FIG. 1a, the device locked;

FIG. 2 is a perspective view of an embodiment of a lock box of the present invention;

FIG. 3 is an exploded perspective view of the device shown in FIG. 2;

FIG. 4 is an exploded perspective view of the lock portion of the device shown in FIG. 3;

FIG. 5a is a cross-sectional view showing a locked state between the lock portion and the container;

FIG. 5b is a cross-sectional view showing an unlock state of the lock portion;

FIG. 6 is a schematic view of an embodiment of the present invention;

FIG. 7 is a schematic view of another embodiment of the present invention;

FIG. 8 is a schematic view of yet another embodiment of the present invention;

FIG. 9 is a schematic view of still yet another embodiment of the present invention;

FIG. 10 is a schematic view showing operation of an embodiment of the lock container of the present invention;

FIG. 11 is a schematic view showing an alternative operation of an embodiment of the lockable container of the present invention;

FIG. 12a is a perspective view showing a locked state of the lock portion of an embodiment of the present invention; and

FIG. 12b is a perspective view showing an unlocked state of the lock portion of an embodiment of the present invention.

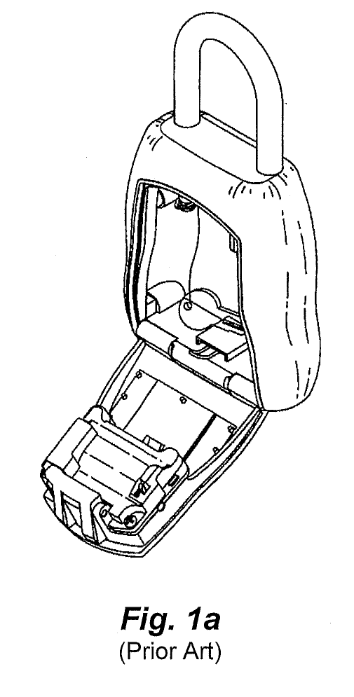

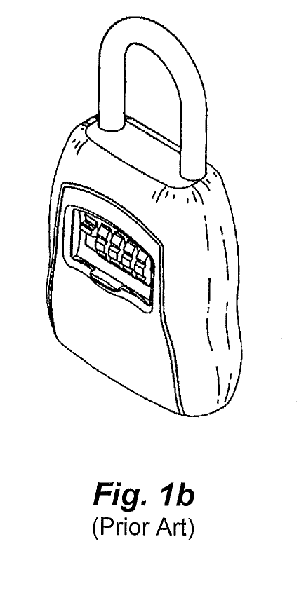

The drawings are not necessarily to scale.

### DETAILED DESCRIPTION

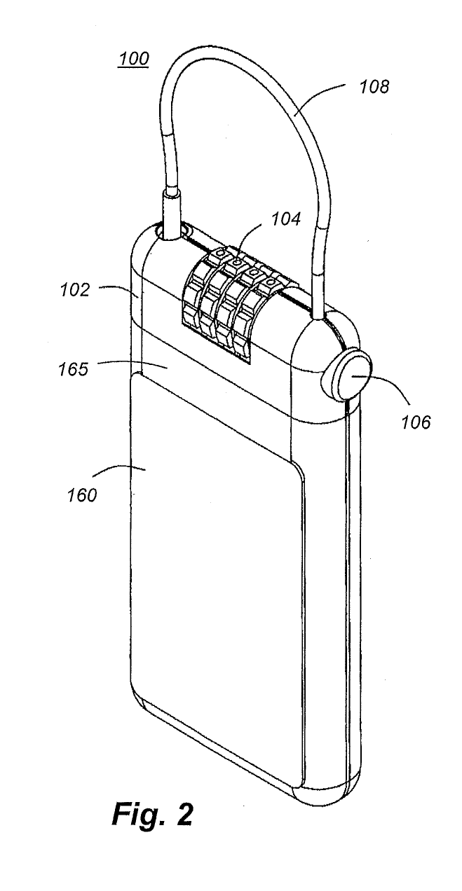

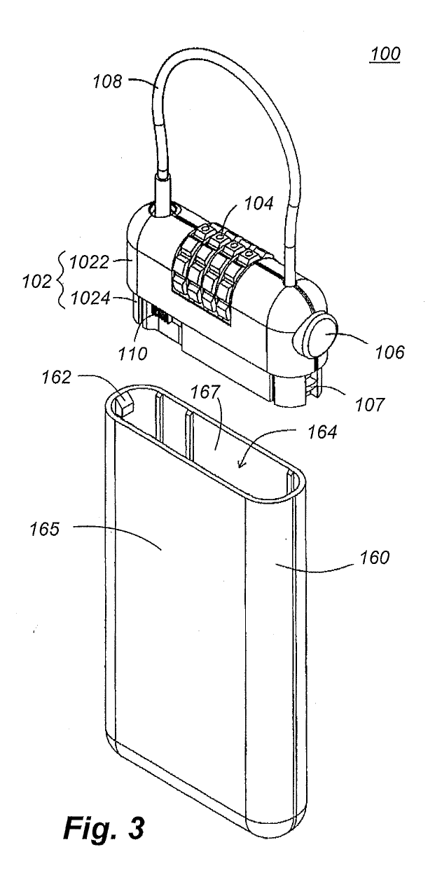

Embodiments of the present invention are illustrated in FIGS. 2-12b. FIG. 2 and FIG. 3 show an embodiment of a lockable container 100 of the present invention. The lockable container 100 includes a lock portion 102 and a detachable container 160. In accordance with at least one embodiment of the present invention, the container can be physically detached from the lock portion 102. The lock portion 102 has a first part 1022 and a second part 1024. In this embodiment, when the lock portion 102 and the container 160 are attached, the first part 1022 and the outer surface 165 of the container 160 form a continuous surface. In this embodiment the container 160 surrounds and encloses the second part 1024. The first part 1022 has a lock mechanism 104 and an opening component 106. A latch 107 is disposed on at least one side of the second part 1024 and is driven by the opening component 106. Alternatively, two or more latches 107 may be employed, such as on opposite sides of the second part 1024.

The container 160 has an opening 167 and defines and inner space 164. At least one latch engaging member 162 is disposed proximate to the opening 167, wherein the latch 107 engages the latch engaging member 162 to secure the container 160 with lock portion 102. It will be appreciated that the latch engaging member 162 may also comprise an opening, notch or other type of catch that operatively cooperates with the latch 107. Alternatively, the wedge or latch engaging member 162 is located in a recessed portion or portions of the container 160. Articles to be secured are passed through the opening 167 into the inner space 164. When locked, the lock mechanism 104 restricts a displacement of the opening component 106 preventing the lock portion 102 from detaching from the container 160. When unlocked, the lock mechanism 104 releases the opening component 106 allowing the lock portion 102 to separate from the container 160. The lock mechanism 104 in the present embodiment includes a combination lock, while in another embodiment (not shown) the lock mechanism 104 may include a key lock. Other embodiments of the present invention may include locking devices having alternative locking systems, including key pads, voice activated locks, fingerprint activated locks or bio-metric locks.

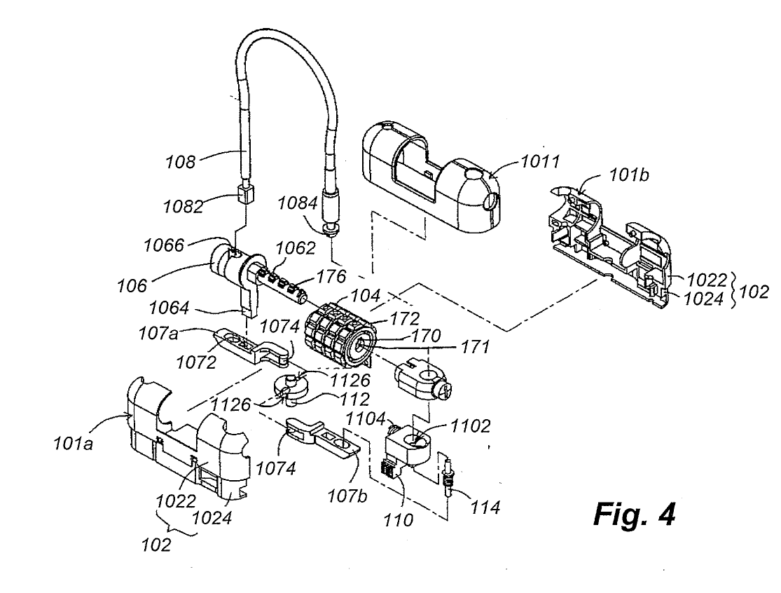

The lockable container 100 further comprises an attaching device 108 and a release mechanism 110. The attaching device 108 is disposed on the first part 1022 of the lock portion 102. In accordance with embodiments of the present invention, the attaching device 108 includes a flexible chain or cable. As FIG. 4 shows, the attaching device 108 has a first end 1082 and a second end 1084 when the attaching device 108 is a cable. The first end 1082 is fixed on the first part 1022 of the lock portion 102 while the second end 1084 is detachably attached to the first part 1022. In another embodiment, the attaching device 108 may be a rigid U-shaped shackle having a first end 1082 with a restricted displacement.

With reference to FIGS. 3 and 4, the release mechanism 110 is disposed on the second part 1024. The release mechanism 110 controls the second end 1084 of the attaching device 108 to either permit it to separate from or attach to the first part 1022. For manufacturing convenience, the lock portion 102 is composed of a housing that includes a first half shell 101a and a second half shell 101b. The first half shell 101a and the second half shell 101b preferably both include portions of the first part 1022 and the second part 1024. Further, an outer shell 1011 fits over and encloses at least a portion of the lock portion 102 to protect its inner components. The outer shell 1011 may be made of rubber, plastic or metal. In addition to providing structural strength, the outer shell 1011 may be used to provide aesthetics to the lockable container.

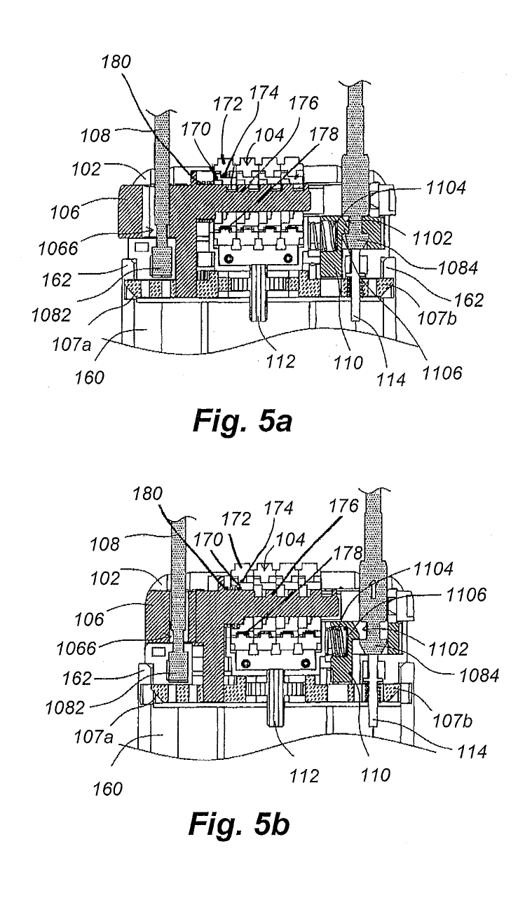

In FIGS. 4, 5a and FIG. 5b, preferred operation steps of the lock mechanism 104 are illustrated. The opening component 106 has an axis rod 1062 and an extending rod 1064 oriented perpendicular to the axis rod 1062. The axis rod 1062 is disposed along and through the axis of the lock mechanism 104, while the extending rod 1064 passes through a hole 1072 of the latch 107a. When the lock mechanism 104 is locked, the axis rod 1062 is prevented from moving axially within the lock mechanism 104 and toward the side of the lock portion 102 opposite from the opening component 106. Conversely, when the lock mechanism 104 is unlocked, the axis rod 1062 is allowed to move axially within the lock mechanism 104 and towards the side of the lock portion 102 opposite from the opening component 106. The extending rod 1064 moves along with the axis rod 1062, which causes the latches 107a and 107b to move laterally, thereby disengaging themselves from the wedge or latching engaging member 162, as discussed in greater detail below.

The lock mechanism 104 may be a multiple-dial combination lock. As is known in the art, this type of lock may include a plurality of sleeves 170 each associated with one of a plurality of numbered dials 172. Each sleeve 170 has external teeth that engage internal teeth 174 disposed on a numbered dial 172. Each sleeve 170 includes a similarly shaped pattern 171 that corresponds to a pattern of notches 176 disposed on the axis rod 1062. When each of the sleeves 170 is rotated into a particular orientation, the sleeve patterns 171 (as best seen in FIG. 4) align with the notches 176 disposed on the axis rod 1062 allowing axial displacement of the axis rod 1062. More particularly, rotating the numbered dials 172 such that lock's 104 combination is displayed causes the sleeves 170 to be driven into the orientation that allows axial displacement of the axis rod 1062. In FIG. 5a, the sleeve patterns 171 and the axis rod notches 176 are not in alignment and, accordingly, the lock mechanism 104 is locked. In FIG. 5b, the sleeve patterns 171 and the axis rod notches 176 are aligned and, accordingly, the lock mechanism 104 is unlocked. The lock mechanism 104 additionally includes a leaf spring 178 to hold the numbered dials in place and a coil spring 180 to normally bias the axis rod 1062 in a locked position.

In a preferred embodiment, two latches 107a and 107b are disposed on opposite ends of the second part 1024 in a collinear arrangement. In another embodiment, however, the second part 1024 may have only one latch 107a. In yet another embodiment, two or more non-collinear latches 107a and 107b are disposed on opposite ends of the second part 1024. Furthermore, the latches 107a and 107b include rod portions 1074 in operative engagement with two concave receptacles 1126 of a projecting part 112. When unlocked, the lock mechanism 104 releases the axis rod 1064 allowing it to be axially displaced. When the opening component 106 is depressed, the axis rod 1062 and the extending rod 1064 (which passes through a hole 1072 in the latch as shown in FIG. 4) move inward at the same time. Inward movement of the extending rod 1064 causes an inward movement of one latch 107a which, in turn, causes the projecting part 112 to rotate. Simultaneously, the concave receptacles 1126 of the projecting part 112 drive the opposite latch 107b on the other side to move inward when the projecting part 112 rotates. Accordingly, when the opening component 106 is pressed down, the latches 107a and 107b inwardly move toward the interior of the lock portion 102 to release the lock portion 102 from the restriction of the wedge 162 of the container 160.

In accordance with embodiments of the present invention, the attaching device 108 is operatable when the container 160 is detached or separated from the lock portion 102. In at least one embodiment of the present invention, the release mechanism 110 disposed on the second part 1024 is operatable only when the release mechanism 110 is exposed. In an alternative embodiment (not shown), the release mechanism may be exposed when the container 160 is attached to the lock portion 102.

Components of the lock portion 102 associated with the operation of the attaching device 108 are illustrated in FIGS. 5a and 5b. In FIG. 5a, one side of the release mechanism 110 has an inverse angle socket 1102 to receive the second end 1084 of the attaching device 108. The release mechanism 110 slides laterally to release a spring 1104 to separate the second end 1084 from a hook 1106 of the release mechanism 110. A spring-loaded piston 114 is used to eject the second end 1084 of the attaching device 108 when it is released by a lateral movement of the release mechanism 110. The separated second end 1084 may penetrate, pass through or otherwise engage or secure an article, then connect back to the inverse angle socket 1102. As shown in FIG. 5b, the second end 1084 is coupled with the release mechanism 110, and released by exerting a force greater than that of the spring 1104. In a preferred embodiment, the first end 1082 is fixed in a penetration hole 1066 of the opening component 106.

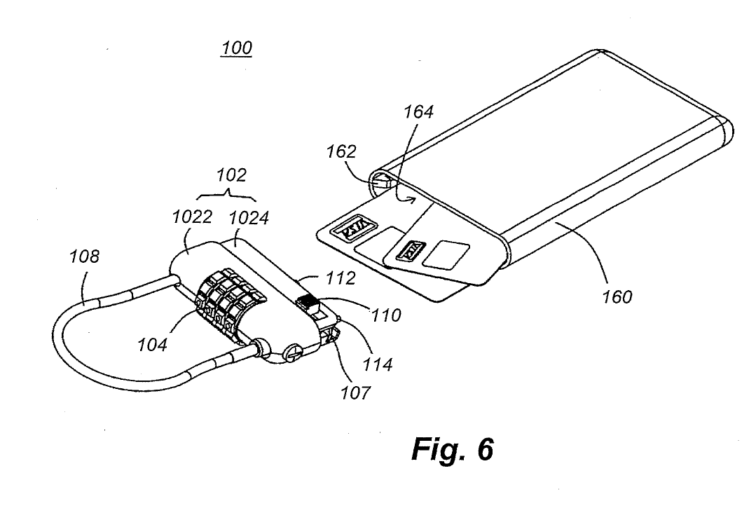

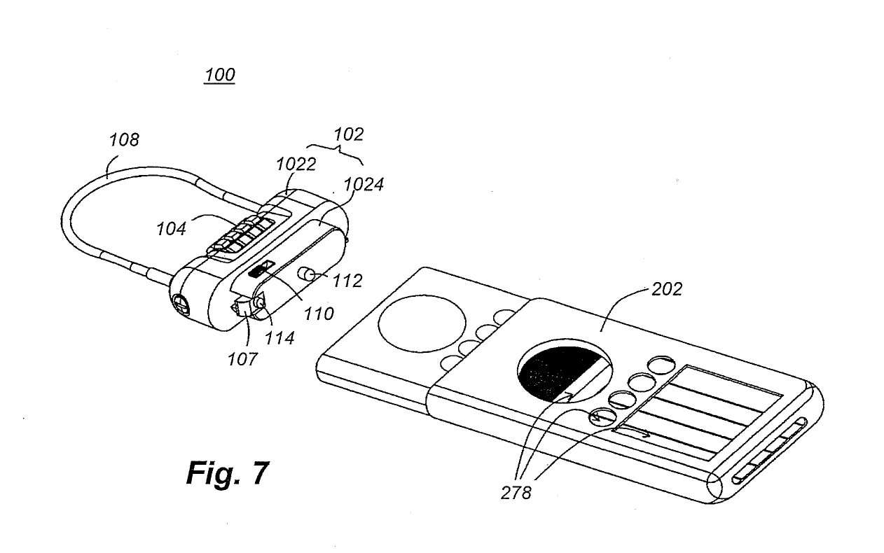

FIG. 6 and FIG. 7 illustrate the operation of a preferred embodiment. The lockable container 100 may include two containers 160 and 202 for receiving different articles. As noted above, and in accordance with one or more embodiments of the invention, the container can be physically detached from the lock portion 102. As shown in FIG. 6, the container 160 may be used to store precious articles such as wallets, and credit cards, keys, depending on size, and/or money. As shown in FIG. 7, the container 202 is used to contain particularly shaped electronic devices such as a MP3 player. Holes 278 are formed on the container 202 corresponding to the controlling panels of the MP3 player. Accordingly, the MP3 player can be operated and controlled via the holes 278 of the container 202 without taking the MP3 player out of the lockable container 202.

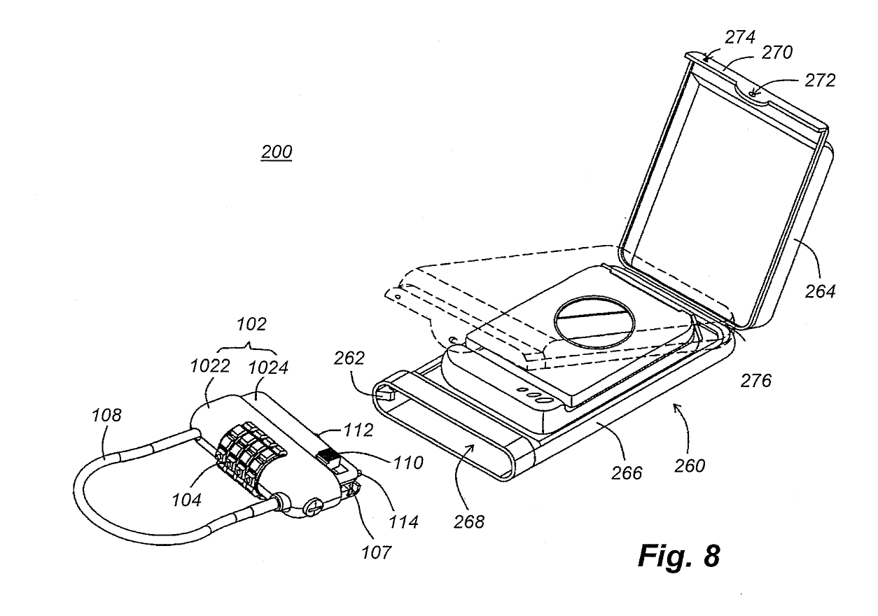

Another preferred embodiment is illustrated in FIG. 8. Except for the container 260, other components and operations are similar to the embodiments mentioned above. A cover 264 of the container 260 of this preferred embodiment is pivotally connected to a housing 266 by a pivot 276. The cover 264 of the container 260 in this preferred embodiment is therefore able to be opened or closed accordingly. Two latch engaging members 262 or cooperative apertures are disposed on the two sides of the opening of the housing 266 to engage the latch 107. The cover 264 and the housing 266 together form an inner space 268.

The cover 264 further includes an end side 270 having at least a hole or aperture 272. In a preferred embodiment, the end side 270 has a first hole 272 and a second hole or aperture 274. The first hole 272 and the second hole 274 are formed corresponding to the projecting part 112 of the second part 1024 and a portion of the spring loaded piston 114. When the lock portion 102 is engaged with the container 260, the projecting part 112 and a portion of the spring loaded piston 114 are disposed in the first hole 272 and the second hole 274 respectively to prevent the cover 264 from opening. Therefore, the cover 264 of the container 260 cannot be opened when the lock mechanism 104 is locked. On the other hand, the container 260 and the lock portion 102 are separable when the lock mechanism 104 is unlocked, and the cover 264 of the container 260 is able to be opened accordingly.

The external shape of the container 260 may be designed for a specific article to be contained in the inner space 268. For example, the external shape of the container 260 may be designed to store a mobile phone or other electronic or non-electronic devices in the inner space 268.

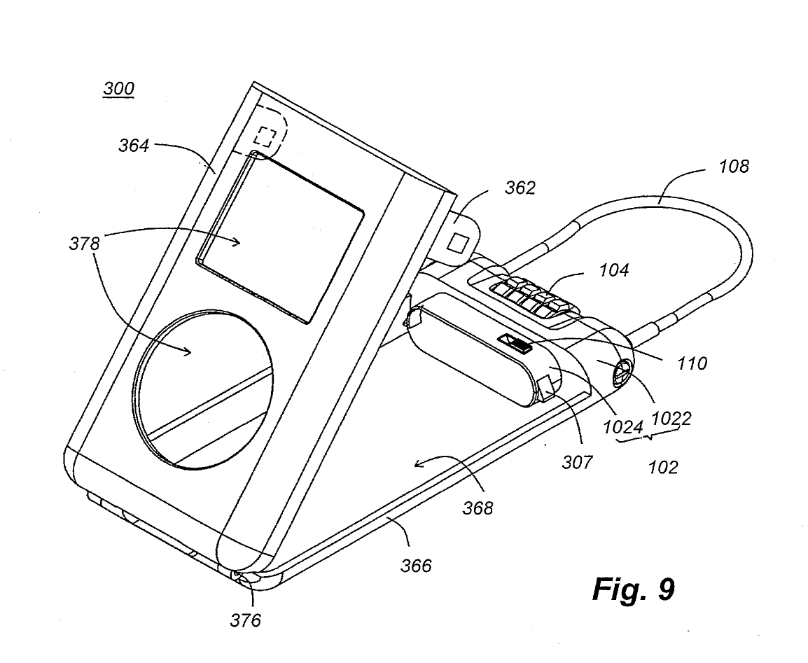

Another preferred embodiment is illustrated in FIG. 9. The lock portion 102 and the housing 366 of the lockable container 300 of the preferred embodiment are integrally formed and therefore interconnected. The lockable container 300 includes a lock portion 102 and a cover 364. The lock portion 102 has a first part 1022, a second part 1024 and a housing 366. As better seen on the similar device depicted in FIG. 3, the first part 1022 has an opening component 106 and at least a lock mechanism 104. The second part 1024 has at least a latch 307 driven by the opening component 106. Referring again to FIG. 9, the housing 366 is an extension part of one side of the first part 1022, The cover 364 is pivotally connected to the housing 366 to form an inner space 368. The cover 364 has at least a latch engaging member 362 or cooperative aperture corresponding to the latch 307. The lock mechanism 104 restricts the displacement of the opening component 106 when the lock mechanism 104 is locked and, as a result, the latch 307 remains laterally extended. Accordingly, when the lock mechanism 104 is locked, the cover 364 cannot be opened. When the lock mechanism 104 is unlocked, the lock mechanism 104 releases the opening component 106 allowing the latch 307 to displace laterally inward, thereby disengaging itself from the latch engaging mechanism 162. Therefore, the cover 364 is able to be opened when the opening component 106 is pressed. The operation of the attaching device 108 and the lock mechanism 104 are similar to the two embodiments mentioned above. The cover 364 is pivotally connected to the housing 366 by a pivot 376. Holes 378 are formed on the cover 364 corresponding to the controlling panel of the electronic devices including MP3 player, hand video game player, PDA or cellular phone.

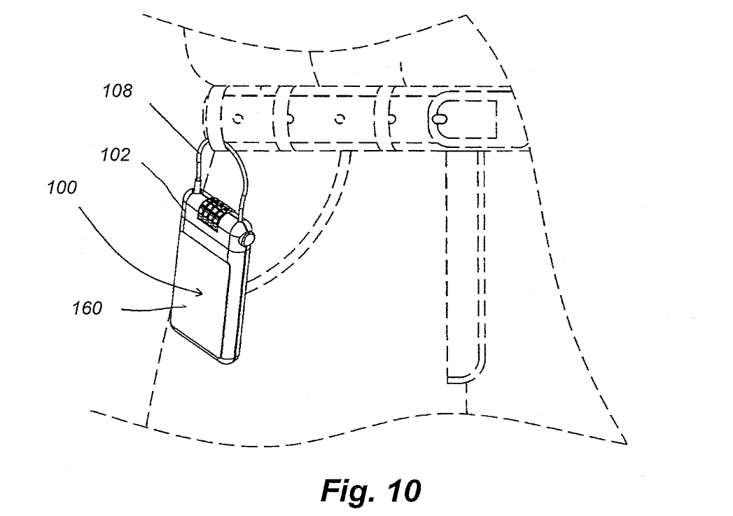

In an embodiment shown in FIG. 10, the attaching device 108 is locked on a waist belt. The attaching device 108 may also be locked on a product or article, such as a chair, a desk, a backpack, purse, bike, scooter, locker or a closed loop door handle. Additionally, the container 160 may be dustproof or waterproof. Shockproof materials, such as sponge, plastic or rubber could be disposed in the inner space to resist shock an vibration.

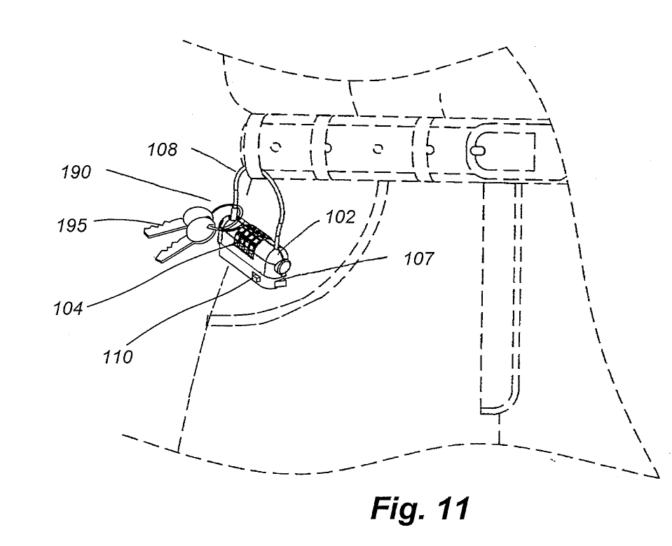

In an alternative embodiment shown in FIG. 11, the attaching component 108 itself is used to secure an article. Accordingly, the lock portion 102 may be used to secure an article regardless of whether or not it is attached to a container 160. In this capacity, the lock portion 102 may be used, for example, to secure keys or other items to a belt. For example, as shown in FIG. 11, the attaching device 108 is threaded through a key chain 190 used to contain a plurality of keys 195, through a belt loop, and then attached to the lock portion 102, as described above. If the lock portion 102 is used in this capacity, the item is secured by means of the attaching device 108 rather than being received by the container 160. Accordingly, it may be desirable to leave the container 160 unattached to the lock portion 102.

In accordance with embodiments of the present invention, structure may be provided for allowing the lock portion to be locked independent of a box or container. That is, a lock portion is provided that has separate utility independent of having a box or container. For such embodiments the second end of the attaching device is prevented from separating from its attachment to the lock portion when the lock mechanism is in a locked position. This allows articles attached by means of attaching component (as shown in FIG. 11) to remain securely locked regardless of whether or not a container is attached to the lock portion.

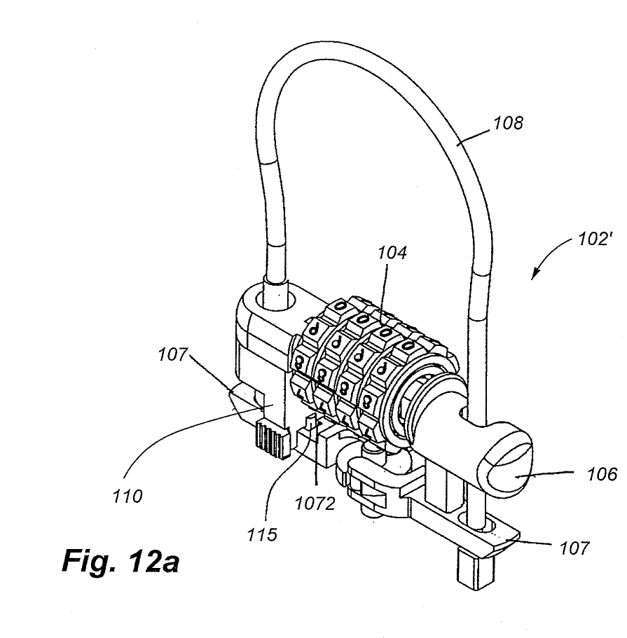

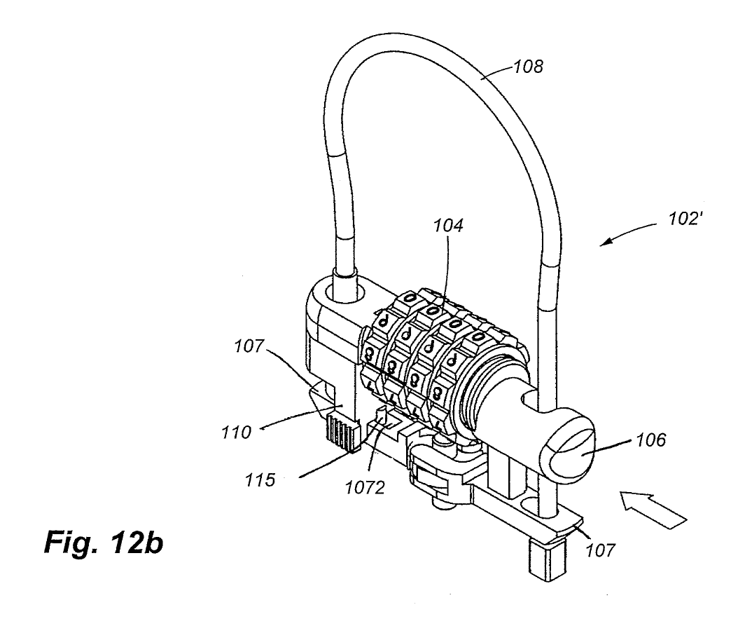

FIGS. 12a and 12b illustrate components of the lock mechanism 102 that operate to prevent the attaching device 108 from separating from the lock portion 102 when the lock mechanism 104 is in a locked position. The release mechanism 110 includes a blocker portion 115 that fits within a hole 1072 of the latch 107. In FIG. 12a, the opening component 106 is not depressed and as a result, the latches 107 remain outwardly displaced. In this position, the blocker 115 is pressed against the side of the hole 1072. Accordingly, the attaching controlling component 110 is prevented from moving inward to release the attaching device 108. In FIG. 12b, the opening component 106 is depressed, and as a result, the latches 107 are displaced inwardly. In this position, a space exists between the blocker 115 and the wall of the hole 1072. As a result, the attaching controlling component 110 is allowed to move inwardly to release the attaching device 108.

As can be seen in FIGS. 12a and 12b, and in accordance with embodiments of the present invention, releasing the attaching device 108 involves two actions. First, the opening component 106 is depressed to move the latches 107 inward, and second, the attaching controlling component 110 is moved inward. If the lock mechanism 104 is locked, pressing the opening component 106 down will not move the latches 107 inward. As a result, the release mechanism 110 is prevented from moving inward to release the attaching device 108. If the lock mechanism 104 is unlocked, depressing the opening component will move the latches 107 inward. As a result, the release mechanism is allowed to move inward to release the attaching device 108.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims. For example, various cooperating locking mechanisms are described herein, including latch 107 and latch engaging member 162, latch 107 and latch engaging members 262, projecting part 112 and first aperture 272, piston 114 and aperture 274, and latch 307 and latch engaging member 362. It will be appreciated by those of skill in the art that the configurations of these locking mechanisms may vary, including where the latch components are protruding members and the engaging members are openings or cooperative catches, or alternatively where the latches are openings or catches and the latch engaging members and apertures are protruding members. The important aspect is that the separate component pieces may be secured to each other and not the structure of the locking mechanism.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit Invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A lockable container, comprising:
a lock portion having a first part and a second part, wherein said first part has at least an opening component and a lock mechanism, said second part having at least a latch being movable together with said opening component;
an attaching device having a first end connected with said first part and a second end detachably connected with said first part; and
a container releasably secured to said second part, wherein a top opening of said container engages said second part of said lock portion, said container having at least an inner space and a latch engaging member;
wherein said lock mechanism disables said opening component when said lock mechanism is in a locked state and said container is secured to said lock portion such that said inner space is not accessible through said top opening, said lock mechanism enables said opening component when said lock mechanism is in an unlocked state, and said container is able to be physically detached from said lock portion in said unlocked state and said inner space is accessible through said top opening.

2. The lockable container of claim 1 further comprising:
a release mechanism disposed on said second part for controlling a detachment between said second end and said first part.

3. The lockable container of claim 2, wherein said attaching device is further interlocked with said opening component for simultaneously controlling said detaching between said second end and said first part and said detaching between said container and said lock portion;
wherein in said locked state said second end is not capable of detaching from said first part, and in said unlocked state said second end is capable of detaching from said first part.

4. The lockable container of claim 1, wherein said container further comprises a housing and a cover pivotally connected with said housing to form said inner space.

5. The lockable container of claim 4, wherein an opening of said cover further includes an end side having an aperture.

6. The lockable container of claim 5, wherein said second part further includes a protrusion corresponding to said aperture.

7. The lockable container of claim 1, wherein said attaching device comprises a chain.

8. The lockable container of claim 1, wherein said attaching device comprises a U-shaped shackle.

9. The lockable container of claim 1, wherein said attaching device comprises a cable.

10. The lockable container of claim 1, wherein said lock mechanism comprises a combination lock.

11. The lockable container of claim 1, wherein said lock mechanism comprises a key operated lock.

12. The lockable container of claim 1, wherein the container is shaped to hold an electronic device and the container includes at least one aperture to access one or more controls of the electronic device.

13. A lockable container, comprising:
a lock portion having a first part, a second part and a housing, wherein said first part has at least an opening component and a lock mechanism, said second part having at least a latch being movable in connection with said opening component, said housing being integrally formed with one side of said first part, said housing including a plurality of openings; and
a cover pivotally connected with said housing to access an inner space defined by said housing and cover, said cover having at least a latch receiving member;
wherein said lock mechanism restricts the displacement of said opening component when said lock mechanism is locked, and wherein said lock mechanism releases the opening component when said lock mechanism is unlocked.

14. The lockable container of claim 13 further comprising:
an attaching device having a first end connected with said first part of the lock portion and a second end detachably connected with said first part; and
a release mechanism disposed on a side of said second part of the lock portion for controlling a detachment between said second end and said first part.

15. The lockable container of claim 14, wherein said attaching device is further interlocked with said opening component for simultaneously controlling said detaching between said second end and said first part and said detaching between said container and said lock portion;
wherein in said locked state said second end is not capable of detaching from said first part, and in said unlocked state said second end is capable of detaching from said first part.

16. The lockable container of claim 13, wherein said cover comprises a pivot.

17. The lockable container of claim 14, wherein said attaching device comprises a chain.

18. The lockable container of claim 14, wherein said attaching device comprises a U-shaped shackle.

19. The lockable container of claim 14, wherein said attaching device comprises a cable.

20. The lockable container of claim 13, wherein said lock mechanism comprises a combination lock.

21. The lockable container of claim 13, wherein said lock mechanism comprises a key operated lock.

22. A method for using a lockable container, said method comprising:
unlocking a lock mechanism to physically detach a container from a lock portion wherein said container has a plurality of opposing sides, the lock portion including an attaching device for interconnecting the lock portion to an object;
depositing at least an article in said container; and
reattaching said container and said lock portion.

23. The method of claim 22, wherein said unlocking step includes activating an opening component to release at least a latch of said lock mechanism from a catch of said container.

24. The method of claim 22, wherein said unlocking step includes operating a release mechanism to disassemble an end of the attaching device from said lock portion when said lock portion releases said container.

25. The method of claim 22, wherein said article includes an electronic device.

26. The method of claim 25, further comprising operating said electronic via an opening of said container.

27. The method of claim 22, wherein said lock mechanism includes a combination lock.

28. The method of claim 22, wherein said lock mechanism includes a key lock.

29. A method of using a lock, the method comprising:
detaching a second end of an attaching device from a lock by actuating an release mechanism, said attaching device having a first end fixedly connected to said lock, said lock including a physically detachable container;
threading said second end of the attaching device through an article and through an object to which the article is be locked;
reattaching said second end to said lock;
wherein said release mechanism is only operable in combination with an opening component that is enabled by a lock mechanism.

30. The method of claim 29, wherein the attaching device is a cable.

31. The method of claim 29, wherein the attaching device is a chain.

32. The method of claim 30, wherein the attaching device is a U-shaped shackle.
